(19) United States
(12) Patent Application Publication
(10) Pub. No.: US 2026/0265464 A1
(43) Pub. Date: Sep. 10, 2026

(54) Systems, Devices And Methods For Producing Thermoplastic Lignocellulose

(71) Applicant: MCMASTER UNIVERSITY, Hamilton (CA)

(72) Inventors: Michael Thompson, Hamilton (CA); Jinlei Li, Hamilton (CA)

(21) Appl. No.: 18/876,370

(22) PCT Filed: Jun. 21, 2023
(86) PCT No.: PCT/CA2023/050861

§ 371 Date: Dec. 18, 2024

Related U.S. Application Data
(60) Provisional application No. 63/354,055, filed on Jun. 21, 2022.

(30) Foreign Application Priority Data
Jun. 21, 2022 (CA) 3164516

(51) Int. Cl. C08H 8/00

(52) U.S. Cl. CPC C08H 8/00

(57) ABSTRACT

Methods of producing thermoplastic lignocellulose are described herein. The methods include mixing a feed stream and a recycle stream to form a mixed feed stream, the feed stream comprising unmodified lignocellulose, the recycle stream comprising modified lignocellulose that has passed through an extruder; providing the mixed feed stream to the extruder at a feed port of the extruder; providing a liquid modifier to the extruder at a second port of the extruder, the second port being downstream from the feed port so that the liquid modifier mixes with the mixed feed stream within the extruder to initiate side-chain modification of the unmodified lignocellulose within the mixed feed stream, the liquid modifier comprising a cationic surfactant/sulfuric acid additive and an esterification agent; and producing a product stream by the extruder at an outlet of the extruder, the product stream comprising the thermoplastic lignocellulose as extrudate.

### CROSS-REFERENCE TO RELATED APPLICATIONS

This application is a 371 National Stage Entry of PCT/CA2023/050861 filed Jun. 21, 2023, which claims the benefit of priority to U.S. Provisional Application No. 63/354,055 filed Jun. 21, 2022, and this application claims the benefit of foreign priority to Canadian Application No. CA 3164516, filed on Jun. 21, 2022, the entire contents of which are incorporated by reference herein in their entirety.

### TECHNICAL FIELD

The embodiments disclosed herein relate to systems, devices and methods for producing lignocellulose, and more specifically, to systems, devices and methods for intensifying thermoplastic lignocellulose production.

### BACKGROUND

The following paragraphs are not an admission that anything discussed in them is prior art or part of the knowledge of persons skilled in the art.

The abundance and renewability of forestry biomass has attracted intense research interest in its use for producing various bio-polymeric products, for example textile and packaging films. However, the conversion of forestry biomass into polymeric products requires more complicated processes than those from fossil fuels, which decreases their competitiveness in commercial applications. Scalable technologies to process forestry biomass are necessary from the point of sustainable development, in order to increase commercial viability. Extrusion technology can be considered as promising in this regard owing to its easy scale-up, cost-effectiveness and capacity for simultaneously defibrillating and modifying wood fibers.

Direct screw extrusion of forestry biomass is challenging since the lignocellulosic fibers exhibit low deformability and no melting point below their decomposition temperature, thus lacking the necessary flowability for most polymer processes. Currently, the most common solution is melt compounding wood fibers into a thermoplastic matrix to generate wood-plastic products. With typically high fiber loadings (60% or higher is not uncommon), the thermoplastic matrix serves as a binder and lubricant in the process. Besides thermoplastic lubricants, using excessive liquid is another way to aid the extrusion of lignocellulosic fibers for preparing bio-based products. For example, preparation of cellulose nanofibers by twin-screw extrusion usually uses a high water content to assist the convey of fibers inside the extruder. In some cases, soluble sugars or polymers are added along with the liquid to act as a lubricant for the fibers, thereby allowing extrusion at higher solids contents.

In cases of reactive extrusion, since many added lubricants can produce undesirable side reactions, an excess of reactants, if liquid, or added solvents are ideal for conveying lignocellulose inside the twin-screw extruder. However, this significant excess of reactants requires complex separations afterwards from the product, leading to increased production capital and energy costs.

Accordingly, in view of the above, there is a need to develop new systems, devices and methods for producing thermoplastic lignocellulose, and particularly new systems, devices and methods for producing thermoplastic lignocellulose that reduce or eliminate the use of contaminates such as but not limited to solvents, or costly additives, that may interfere with performance of the final thermoplastic product.

### SUMMARY

In accordance with a broad aspect, a method of producing thermoplastic lignocellulose is described herein. The method includes mixing a feed stream and a recycle stream to form a mixed feed stream, the feed stream comprising unmodified lignocellulose, the recycle stream comprising modified lignocellulose that has passed through an extruder; providing the mixed feed stream to the extruder at a feed port of the extruder; providing a liquid modifier to the extruder at a second port of the extruder, the second port being downstream from the feed port so that the liquid modifier mixes with the mixed feed stream within the extruder to initiate side-chain modification of the unmodified lignocellulose within the mixed feed stream, the liquid modifier comprising a cationic surfactant/sulfuric acid additive and an esterification agent; and producing a product stream by the extruder at an outlet of the extruder, the product stream comprising the thermoplastic lignocellulose as extrudate.

In at least one embodiment, the extruder has a temperature of about 25° C. at the feed port.

In at least one embodiment, the extruder is water cooled to provide the temperature of about 25° C. at the feed port.

In at least one embodiment, the mixing of the feed stream and the recycle stream comprises dry blending the feed stream and the recycle stream.

The method of any one of claims 1 to 4, wherein the mixing of the feed stream and the recycle stream comprises mixing of the feed stream and the recycle stream so that the modified lignocellulose of the recycle stream forms about 25 wt % of the total mass of the unmodified lignocellulose and the modified lignocellulose.

In at least one embodiment, the mixing of the feed stream and the recycle stream comprises mixing of the feed stream and the recycle stream so that the modified lignocellulose of the recycle stream forms about 50 wt % of the total mass of the unmodified lignocellulose and the modified lignocellulose.

In at least one embodiment, the second port is in a second barrel zone of the extruder.

In at least one embodiment, the extruder has a temperature of about 120° C. at the second port.

In at least one embodiment, the extruder has a temperature of about 120° C. between the second port and the outlet.

In at least one embodiment, the liquid modifier stream is injected at a rate of about 32 mL/min.

In at least one embodiment, the liquid modifier stream comprises a fluid comprising one or more of: benzethonium chloride (hyamine, HPLC grade), sodium bicarbonate, phenolphthalein (ACS grade), acetic anhydride (reagent grade), sulfuric acid (trace metal grade), anhydrous ethanol (reagent grade), and 1.0 M sodium hydroxide and hydrochloric acid solutions.

In at least one embodiment, the method includes separating a portion of the extrudate product stream to form the recycle stream.

According to one particular aspect, the invention relates to a mixed feed stream of lignocellulose for producing thermoplastic lignocellulose, comprising:
unmodified lignocellulose, and
modified lignocellulose that has passed through an extruder.

According to another particular aspect, the invention relates to a mixed feed stream of lignocellulose as defined herein, for use as an innate lubricant in a process for producing thermoplastic lignocellulose.

According to another particular aspect, the invention relates to a compression mouldable thermoplastic lignocellulose, comprising one or more of the following mechanical properties:
a tensile a strength of about 18 to about 31 MPa;
a tensile modulus of about 816 to about 1570 MPa; and
an elongation-at-break of about 2.6% to about 6.1%.

According to another particular aspect, the invention relates to a compression-molded article of manufacture, prepared by compression molding of a compression mouldable thermoplastic lignocellulose as defined herein.

These and other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein and to show more clearly how these various embodiments may be carried into effect, reference will be made, by way of example, to the accompanying drawings that show at least one example embodiment which are now described. The drawings are not intended to limit the scope of the teachings described herein.

FIG. 1 is a side view of a win-screw extruder (18 mm, 40 L/D, Leistritz twin-screw extruder) for the reactive extrusion of lignocellulose.

FIG. 2 is a flow diagram of the reactive extrusion of lignocellulose showing a recycle stream, according to at least one embodiment described herein.

FIG. 3 is a graph showing extruder torque (%) during reactive extrusion of lignocellulose with (R-25 and R-50) and without a recycle stream (B-25 and B-50) based on different solids content.

FIG. 4A is a graph showing viscosity of an Innate lubricant versus temperature at 0.1 s-1.

FIG. 4B is a graph showing viscosity of an innate lubricant versus shear rate at 120° C.

FIG. 5A is a graph showing reaction effectiveness of acetylation of the reactive extrusion processes with and without a recycle stream. The control was the cleaned sample of the lubricant.

FIG. 5B is a graph showing reaction effectiveness of sulfate attachment of the reactive extrusion processes with and without a recycle stream. The control was the cleaned sample of the lubricant.

FIG. 6 is a graph showing Tg temperatures of the modified lignocellulose prepared by a reactive extrusion process according to at least one embodiment described herein with and without a recycle stream. The control was the cleaned sample of the lubricant.

FIG. 7A is a graph showing viscosity curves of samples with different Tg from B-25 series. The inserts are images of the compression-molded samples with different Tg.

FIG. 7B is a graph showing viscosity curves of samples with different Tg from R-25 series. The inserts are images of the compression-molded samples with different Tg.

FIG. 7C is a graph showing viscosity curves of samples with different Tg from B-50 series. The inserts are images of the compression-molded samples with different Tg.

FIG. 7D is a graph showing viscosity curves of samples with different Tg from R-50 series. The inserts are images of the compression-molded samples with different Tg.

FIG. 8A is a graph showing tensile modulus of the modified lignocellulose prepared by reactive extrusion with and without a recycle stream, R-25 versus B-25. The control was the cleaned sample of the lubricant.

FIG. 8B is a graph showing tensile modulus of the modified lignocellulose prepared by reactive extrusion with and without a recycle stream, R-50 versus B-50. The control was the cleaned sample of the lubricant.

FIG. 9 shows a scheme for reactive extrusion process for producing thermoplastic lignocellulose.

Further aspects and features of the example embodiments described herein will appear from the following description taken together with the accompanying drawings.

### DETAILED DESCRIPTION

Various apparatus and methods will be described below to provide an example of one or more embodiments. No embodiment described below limits any claimed embodiment and any claimed embodiment may cover apparatus or methods that differ from those described below. The claimed embodiments are not limited to apparatus and methods having all of the features of any one apparatus or method described below or to features common to multiple or all of the apparatus and methods described below. It is possible that an apparatus or method described below is not an embodiment of any claimed embodiment. Any embodiment disclosed below that is not claimed in this document may be the subject matter of another protective instrument, for example, a continuing patent application, and the applicants, inventors or owners do not intend to abandon, disclaim or dedicate to the public any such embodiment by its disclosure in this document.

Furthermore, it will be appreciated that for simplicity and clarity of Illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It should be noted that terms of degree such as “substantially,” “about,” and “approximately” as used herein mean a reasonable amount of deviation of the modified term such that the end result is not significantly changed. These terms of degree should be construed as including a deviation of the modified term, such as 1%, 2%, 5%, or 10%, for example, if this deviation does not negate the meaning of the term it modifies.

Furthermore, the recitation of any numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about,” which means a variation up to a certain amount of the number to which reference is being made, such as 1%, 2%, 5%, or 10%, for example, if the end result is not significantly changed.

It should also be noted that, as used herein, the wording “and/or” is intended to represent an inclusive-or. That is, “X and/or Y” is intended to mean X, Y or X and Y, for example. As a further example, “X, Y, and/or Z” is intended to mean X or Y or Z or any combination thereof. Also, the expression of A, B and C mean various combinations, including A; B; C; A and B; A and C; B and C; or A, B and C.

The following description is not intended to limit or define any claimed or as yet unclaimed subject matter. Subject matter that may be claimed may reside in any combination or sub-combination of the elements or process steps disclosed in any part of this document, including its claims and figures. Accordingly, it will be appreciated by a person skilled in the art that an apparatus, system or method disclosed in accordance with the teachings herein may embody any one or more of the features contained herein and that the features may be used in any particular combination or sub-combination that is physically feasible and realizable for its intended purpose.

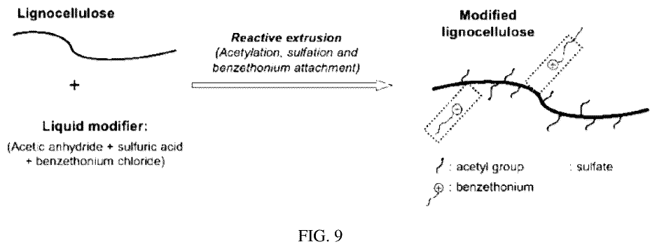

Recently, there has been a growing interest in developing new systems and methods of for producing thermoplastic lignocellulose. Previous studies introduced a reactive extrusion process for producing thermoplastic lignocellulose. This approach is shown in FIG. 9.

The bulk acetylation reaction for lignocellulose requires lubrication in order to be carried out with a twin-screw extruder. Previous studies have demonstrated that a liquid reactant, or liquid modifier, may be used to aid the extrusion of lignocellulose by a twin-screw extruder. Low viscosity solvents or an excess of the anhydride reactant is a common lubricant, but this use requires expensive recovery operations at the end of the reaction to produce a ready-to-use sustainable thermoplastic.

Herein, use of a recycle stream as a chemical unit operation in a reactive extrusion process for producing thermoplastic lignocellulose is described. The modified material (e.g., modified lignocellulose) being recycled back into the extruder used in the extrusion process acts as a lubricant for unmodified lignocellulose of a feed stream to promote conveying and mixing of the unmodified lignocellulose within the extruder. Additionally, the modified material (e.g., modified lignocellulose) being recycled back into the extruder used in the extrusion process promotes conveying and mixing of the unmodified lignocellulose within the extruder without introducing contaminates like solvents or costly additives that have historically been used and may interfere with the performance of the final thermoplastic product.

It has been determined that reducing the reactant concentration relative to the neat lignocellulose produced less functionalization of the biopolymer but the materials created with the recycled content showed higher flowability relative to comparable conditions where only the reactants lubricated the system.

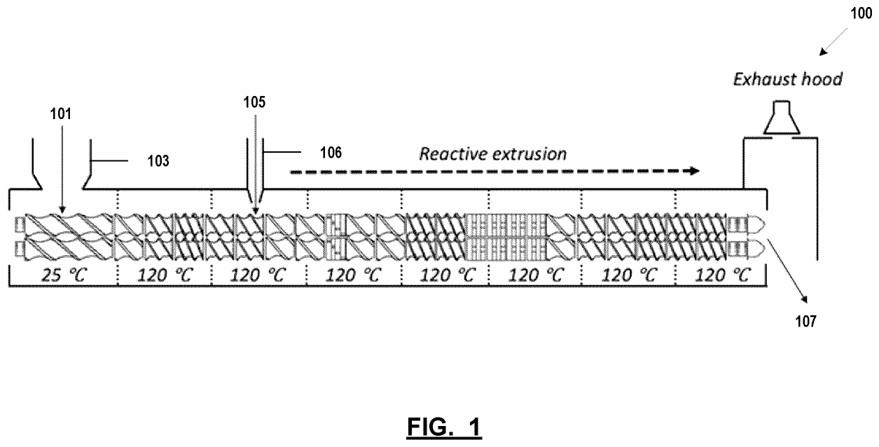

Turning to FIG. 1, illustrated therein is a schematic diagram of a twin-screw extruder for the reactive extrusion of lignocellulose, In the studies described herein, an 18 mm, 40 L/D, Leistritz twin-screw extruder was used.

FIG. 1 shows an extruder 100 having a feed stream 101 of lignocellulose. The lignocellulose, for example, may be received as a high-yield Aspen mechanical pulp (e.g. supplied by Tembec (Montreal, Canada). The lignocellulose of feed stream 101 may contain Klason lignin, such as but not limited to 8.2 wt % Klason lignin as determined by the TAPPI-T method 222 om-02.

In at least one embodiment, the lignocellulosic fibers of feed stream 101 may be mechanically pre-treated before reactive extrusion. In at least one embodiment, the lignocellulosic fibers of feed stream 101 may be mechanically pre-treated before reactive extrusion by using a 27 mm 40 L/D twin-screw extruder (Leistritz, USA). As a result of the treatment, the received fluffy lignocellulosic fibers may become compacted into fine granules, making it convenient for feeding the lignocellulose into the extruder 100, but also improving the chemical accessibility of the lignocellulose by partial microfibrillation.

The lignocellulose of feed stream 101 is received at a feed port 103 of extruder 100. In at least one embodiment, the lignocellulose may be air-dried. The lignocellulose of feed stream 101 may be fed to feed port 103 by a gravimetric feeder, for example at a rate of 500 g/h. Typically, at the feed port 103, the extruder has a temperature of about 25° C. In at least one embodiment, the extruder 100 is water cooled to achieve a temperature of about 25° C. at the feed port 103.

In at least one embodiment described herein, a liquid modifier stream 105 is introduced to the extruder 100 by way of a second port 106.

In at least one embodiment liquid modifier stream 105 comprises a fluid comprising a cationic surfactant/sulfuric acid additive and an esterification agent. In at least one embodiment, liquid modifier stream 105 comprises a fluid comprising one or more of: benzethonium chloride (hyamine, HPLC grade), sodium bicarbonate, phenolphthalein (ACS grade), acetic anhydride (reagent grade), sulfuric acid (trace metal grade), anhydrous ethanol (reagent grade), and 1.0 M sodium hydroxide and hydrochloric acid solutions. For example, in at least some prior studies, a liquid modifier stream 105 comprised a fluid comprising acetic anhydride, benzethonium chloride and sulfuric acid with a molar ratio of 13:1:0.95. Liquid modifier stream 105 may be injected in any manner known to those skilled in the art, such as but not limited to injected using an Optos series metering pump for differing liquid/solids ratios.

Reactive extrusion of the lignocellulose of feed stream 101 and the liquid modifier stream 105 then occurs downstream of the second port 106. The extruder 100 typically has a temperature of about 120° C. at second port 106 and downstream of second port 106. Second port 106 may be referred to as being in the second barrel zone of extruder 100.

In at least one embodiment, the liquid modifier stream 105 is injected at a rate of about 32 mL/min, or at 32 mL/min, corresponding to a 19 wt % solids content (see Table 1, below).

The extruded mass is collected as a product stream 107 and air-dried to constant weight in a fume hood for a period of time, such as but not limited to one week. The resulting material is referred to hereinafter as an “innate lubricant”.

In at least one embodiment, the innate lubricant is redirected back into the extruder, such as but not limited being redirected into the extruder 100 via a recycle stream 108.

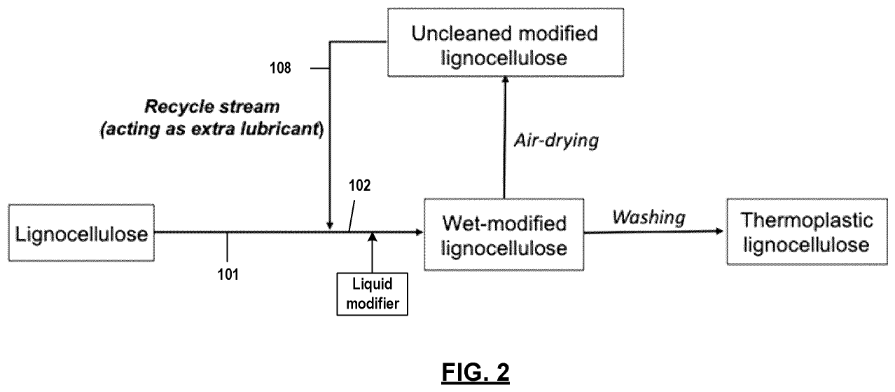

Referring now to FIG. 2, illustrated therein is a process 200 for producing thermoplastic lignocellulose, according to at least one embodiment described herein. In this embodiment, a recycle stream 108 is mixed with feed stream 101 prior to feed stream 101 being added to extruder 100 to form a mixed feed stream 102.

In at least one embodiment, recycle stream 108 comprises innate lubricant (as defined above). In at least one embodiment, the innate lubricant is dry blended with unmodified (i.e. neat) lignocellulose prior to the neat lignocellulose being added to extruder 101. In this case, the mixed neat lignocellulose and innate lubricant are fed into extruder 100 together as mixed feed stream 102.

In at least one embodiment, the innate lubricant is dry blended at 25 wt % of the total mass of the innate lubricant and the lignocellulose. In at least one embodiment, the innate lubricant is dry blended at 50 wt % of the total mass of the innate lubricant and the lignocellulose.

In at least air-dried innate lubricant was ground into fine particles prior to being mixed with the neat lignocellulose, such as but not limited to by a countertop blender, for a period of time, such as but not limited to about 10 mins, at a speed of about 750 rpm. In at least one embodiment, the fine particles of air-dried innate lubricant are able to pass through a 20-mesh sieve.

Table 1, below, shows exemplary feeding compositions of reactive extrusion of lignocellulose for preparing lubricant and thermoplastics. As shown in Table 1, for the 25% recycle series, liquid injection rates may be in a range of 6 to 18 mL/min or about 18, 15, 12, 9 or 6 mL/min, corresponding to a solids content of 30, 34, 39, 46 or 56 wt %, respectively. For the 50% recycle series, the liquid injection rate may be in a range of about 4 to 12 mL/min, or may be either 12, 10, 8, 6 or 4 mL/min, with a corresponding solids content of 39, 43, 49, 56 or 65 wt %, respectively.

After producing the product stream 108, the extrudate of the product stream 108 of each series is collected, cooled in distilled water, and neutralized with 1 M sodium bicarbonate solution before being washed with distilled water until the filtrate conductivity (e.g., determined by a Mettler Toledo S230 conductivity meter) is similar to distilled water.

The modified samples were then vacuum oven dried at a temperature and for a period of time, such as but not limited to at 75° C. for 24 hours, prior to storage and characterization.

### Results

The majority of samples produced by the systems and methods described herein show good thermoplasticity to be melt molded. Only for one specific condition, using 25% recycled content at a total lignocellulose content of 36 wt % produced a synergistic improvement in reaction system to higher grafted content (and lower Tg) compared to modified materials created with a large excess of reactant (19 wt % of the lignocellulose). With 25% recycle stream, the process showed a higher reaction effectiveness, better than the extrusion process operated without recycle content. With a 50% recycle stream, the process showed some negative effects on the reaction, suggesting the innate lubricant was shielding the reactive sites in lignocellulose from the reactants. The tensile testing demonstrated that a recycle stream also benefited to the final product to have better mechanical property. Overall, the study has shown a viable approach to the bulk modification of lignocellulose from a commercial viewpoint where any subsequent cleaning step would lower the competitiveness of the biopolymer in a synthetic resin market.

TABLE 1
Feeding Compositions of Reactive Extrusion of Lignocellulose
for Preparing Lubricant and Thermoplastics.

| | | | Liquid | | | |
|---|---|---|---|---|---|---|
| | Lubricant | Neat | injection | Liquid/neat | Solids | Total |
| | in solids | lignocellulose | rate | lignocellulose | content | lignocellulose |
| Series | (wt %) | in solids (wt %) | (mL/min) | (mL/g) | (wt %) | content (wt %) |
| Lubricant | 0 | 100 | 32 | 3.8 | 19 | 19 |
| R-25 | 25 | 75 | 6, 9, 12, 15, | 1.0-2.9 | 30-56 | 27-51 |
| | | | 18 | | | |
| B-25 | 0 | 100 | 9, 12, 15, 18 | 1.1-2.2 | 30-46 | 30-46 |
| R-50 | 50 | 50 | 4, 6, 8, 10, | 1.0-2.9 | 39-65 | 32-55 |
| | | | 12 | | | |
| B-50 | 0 | 100 | 8, 10, 12 | 1.0-1.4 | 39-49 | 39-49 |

It should be understood that lower liquid injection rates than shown above did not work for B-25 and B-50 series as the extruder motor load exceeded the maximum.

### Gravimetric Analysis

After air-drying the innate lubricant, the residual liquid left in the modified lignocellulose material was estimated by vacuum drying. Five air-dried samples were further dried under a 30 Hg vacuum until reaching constant weight. The weight change was determined as the residual anhydride in the innate lubricant (for which the liquid injection rate was adjusted in the two recycle series to obtain the desired solids ratio). After vacuum drying, the modified lignocellulose was cleaned by repeated soaking in distilled water until the filtrate conductivity matched the water. The weight change after washing was attributed to unreacted hyamine/sulfuric acid (and their intermediates, ex. benzethonium bisulfate 20) remained in the lubricant; the baseline samples were corrected for the unreacted benzethonium functionalizing agent.

### Degree of Chemical Modification and Reaction Effectiveness

Acetyl and benzethonium sulfate contents of the modified pulp were determined by colorimetric titration and elemental analysis, following a previously established approach. Briefly, 0.05 g dried modified lignocellulose was soaked in 5 ml of 0.25 M NaOH and 5 mL of anhydrous ethanol for 24 h to completely hydrolyze acetyl species and partially hydrolyze sulfate ester in the modified lignocellulose. The total amount of the two hydrolyzed esters was estimated by adding 10 ml of 0.25 M HCl and then back titrating the mixture with 0.25 M NaOH and a phenolphthalein indicator.

The amount of benzethonium sulfate species in the modified lignocellulose before and after NaOH treatment was determined by elemental analysis. Elemental nitrogen (N) and sulfur(S) contents were determined with a UNICUBE elemental analyzer (Elementar, German). Approximately 2 mg powder sample was sealed in Tinfoil for the elemental testing.

Based on the measured acetyl and benzethonium sulfate content in the modified lignocellulose, the reaction effectiveness (mmol/g) were the amounts of the two grafted species, corrected for the amount of lignocellulose in the feedstock to the extruder. The baseline conditions contained 100% neat lignocellulose, while for the recycle series, contained a mixture of neat lignocellulose and modified lignocellulose in the innate lubricant.

### Thermal and Rheological Properties

Glass transition temperature (T_{g}) was determined by a Q200 differential scanning calorimeter (TA Instruments, USA) operating in modulated mode. Modified lignocellulose, 9 mg, was loaded and sealed into a Tzero aluminum pan. A hole was punched into the lid to allow moisture evaporation during the test. Samples were equilibrated at −20° C., then scanned till 220° C. at a ramp rate of 5° C./min and an oscillation of 1.00° C. every 60 seconds. The reversible heat flow component was separated from the total heat flow by the Universal Analysis software (TA Instruments, USA) and used to determine T_{g} of the modified samples.

The flowability of the innate lubricant and the modified samples were measured with a Discovery HR-2 hybrid rheometer (TA Instruments, USA) by conducting. Approximate 0.5 g powder was evenly loaded onto the plate of the rheometer and compressed with a 10 N axial force. A temperature sweep was conducted with a heating-cooling mode over a temperature range of 50-210° C. at a rate of 5° C./min and under a constant shear rate of 0.1 s⁻¹. The viscosity of the cooling recycle was reported. A flow sweep at 120° C. was conducted for the lubricant over a shear rate range of 0.1-100 s⁻¹.

Tensile testing was conducted by following standard ASTM D638 and measured with dog-bone shaped specimens prepared by compression molding. The tensile testing was performed at a 5 mm/min crosshead speed, with forces recorded using a 500 N load cell. Tensile properties were reported as an average of three repeats. Compression molding of the modified samples was done with a benchtop hydraulic press (Carver 4389) with heated platens. Molding was done at 180° C.; a 2.5 MPa pressure was applied for 3 mins and then 6 MPa for another 12 mins.

### Influence of the Recycle Stream on Processing of Lignocellulose by Twin-Screw Extrusion

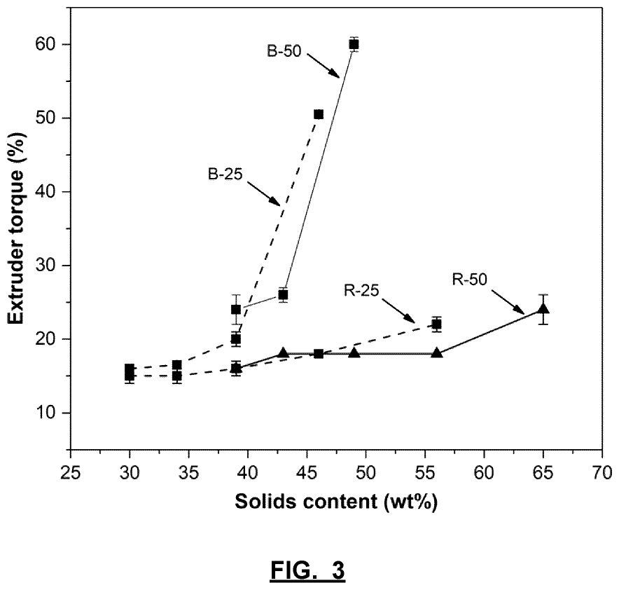

FIG. 3 is a graph showing (as a percentage of maximum torgue capacity) for the 18 mm twin-screw extruder with different lubrication schemes. For the same solids content, the torgue for extruding lignocellulose with the internal lubricant as representative of a varying recycle stream (R-25 and R-50) was notably lower than the baseline conditions extruding neat lignocellulose (B-25 and B-50) for most conditions. Only at the two lowest solids content, while at 30% or 34% for the 25% group (R-25 and B-25), did the liguid modifier show similar lubricity as the innate lubricant on the process (approx. 16% torgue). At higher solids ratios, the torgue rose exponentially for the B-25 series, and the extruder could not handle the torgue demand associated with solids ratios above 46% (50% torgue). Comparatively, the torgue rose gradually to only 18% at solids ratio of 46% for the R-25 series and reached only 20% at the highest tested condition of 56%.

Torgue for the higher recycle condition, R-50 series, showed a similar trend to the R-25 series, and yet R-50 always experienced lower torgue than B-50. Torgue for the baseline series B-50 showed a similar exponential rise as seen with the B-25 series, as the solids ratio increased above 43%. The machine could not be operated above solids ratio of 49% for B-50. In contrast, the presence of innate lubricant enabled the R-50 series to be operated at the highest solids ratio of 65% at only 23% torgue.

The torgue for the B-50 series was slightly lower than for B-25 because the liguid modifier of the former contained more hyamine/sulfuric acid to correct for the higher amount of unbounded benzethonium functionalizing agent in the R-50 series from the innate lubricant. Overall, the results show that recycling a portion of the modified lignocellulose back to the feed stream was much more effective at lowering motor demand than using the liquid modifier. Reactive extrusion at very high solids content was found to be feasible with a recycle stream.

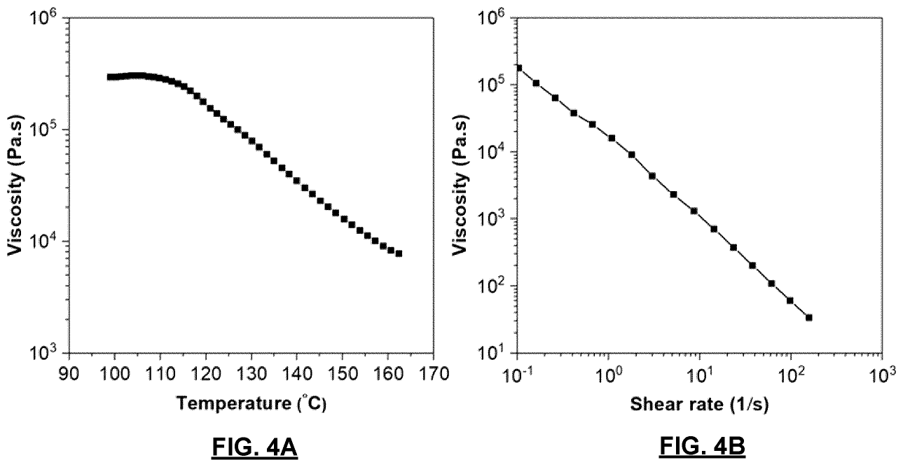

Understanding how the innate lubricant promoted neat lignocellulose's conveyance in the twin-screw extruder was considerably clearer by the rheological analysis of the lubricant. FIGS. 4A and 4B present the viscosity curves versus temperature and shear rate for the innate lubricant. FIG. 4A shows that system temperatures above 105° C. were necessary for thermoplastic lignocellulose to transition from a solid-like response to an increasingly viscous response. For a temperature of 120° C., as used in the extruder, its viscosity was around 1.5×10⁵ Pa-s, even at the low shear rate of 0.1 s⁻¹ used for the temperature sweep.

FIG. 4B shows shear dependency at 120° C., with the innate lubricant showing significant shear thinning over the three decades of shear rate and no evidence of a Newtonian plateau. At a shear rate of 10 s⁻¹, the viscosity had dropped to around 1000 Pa-s which is comparable to commercial resins used for profile applications. The average shear rate (y) for the innate lubricant in the extruder corresponding to the gap clearance in the kneading sections could be estimated by the following equation according to Vergnes's method²¹:

$$γ = - \frac{V cos θ}{2 h} + \frac{3 {Q}_{c h}}{W {h}^{2}} \qquad ( 1 )$$

Where h and 1/1/were the depth and width of the screw channel assumed to be rectangular, which can be estimated from the screw's actual demensions according to Booy's method.²² For a 90° kneading disk of the 18 mm Leistritz twin-screw extruder, the h=2.9 mm and W=6.1 mm. V, O_{C}h and ⊚ were defined as:

$$V = \frac{2 π N R}{60} \qquad ( 2 )$$

$${Q}_{c h} = \frac{Q}{ρ ( 2 n - 1 )} \qquad ( 3 )$$

$$tan θ = \frac{B}{2 π R} \qquad ( 4 )$$

Where /V was the screw rotation speed (100 rpm), R was the screw radius (8.8 mm), Q was the mass flow rate (0.5 kg/h), p was the meit density (1.3 g/mL), n was the number of flights (4), and B was the screw pitch (10.7 mm). At the chosen screw speed of 100 rpm, the estimated average shear rate was 62 s⁻¹, corresponding to a viscosity of 108 Pa-s for the lubricant. Its flowability and hence lubrication behavior were comparable to rosin or a polyethene wax.

Modification Effectiveness of the Reactive Extrusion with a Recycle Stream

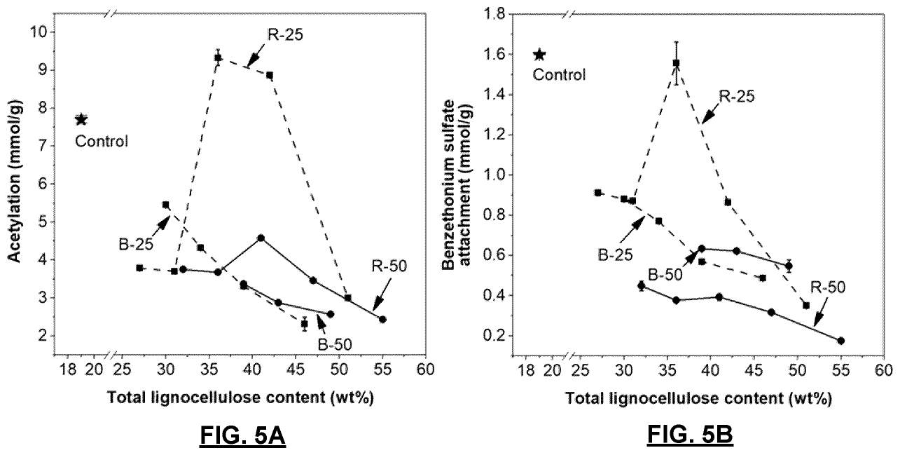

A previous study demonstrated that the modified lignocellulose exhibits grafted acetyl group and, to a lesser degree, grafted benzethonium sulfate groups, with both being important to the flowable nature of the biopolymer. FIGS. 5A and 5B show the reaction effectiveness based on the amounts of acetyl and benzethonium sulfate groups grafted during the reactive extrusion (with functionalities present in the lubricant from the first pass of extrusion, being removed from the results). It should be recognized that reaction effectiveness assumes the modified lignocellulose in the innate lubricant will undergo further significant modification since it is calculated based on the amount of total lignocellulose fed into the extruder.

For the baseline series B-25 without innate lubricant, its reaction effectiveness declined with higher lignocellulose content (LC); grafting attachments decreased for acetyl and benzethonium sulfate in this case. However, the R-25 series found a significant increase in reaction effectiveness with increasing LC, reaching a maximum at 36 wt % LC and subsequently declined at very high LC to ultimately match the other series. The reaction effectiveness at 36 wt % LC was based on 9.3 mmol/g of newly acetyl grafted content, and 1.6 mmol/g of newly benzethonium sulfate grafted content, which was even higher than the values found in the innate lubricant. As a matter of reference, the cleaned modified lignocellulose in the innate lubricant had 7.7 mmol/g acetyl content and 1.6 mmol/g benzethonium sulfate content despite being prepared with an excess of reactant (LC of 19 wt %). These results show that there can be some synergies found in terms of the extent of reaction by relying on the innate lubricant rather than an excess of liquid modifier to aid flowability (and mixing) inside the extruder. However, the results below show that too many recycled materials will have a negative effect on the extent of reaction.

The reaction effectiveness in the R-50 series for both acetylation and benzethonium sulfate attachment was significantly lower than the R-25 series. There was a significant increase in acetyl content but a significant decline in benzethonium sulfate content for the R-50 series compared to the B-50 series over the range of tested LC; acetyl content reached a maximum of 4.6 mmol/g at 41 wt % LC. Several possible factors could have contributed to the low reaction effectiveness of the R-50 series: (i) the innate lubricant mixed well the neat lignocellulose and consequently decreased accessibility of the neat lignocellulose to the liquid modifier; and (ii) the innate lubricant at this high concentration interfered with defibrillation as a necessary action inside the extruder for chemical access to the lignocellulose.

Between the two-baseline series, B-25 and B-50, the extent of acetylation was the same, but the benzethonium sulfate attachment was slightly greater for B-50, possibly because of the higher hyamine/sulfuric acid functionalizing agent which was being compensated for in the R-50 series.

### Thermoplasticity of the Modified Lignocellulose Based on Recycle Series

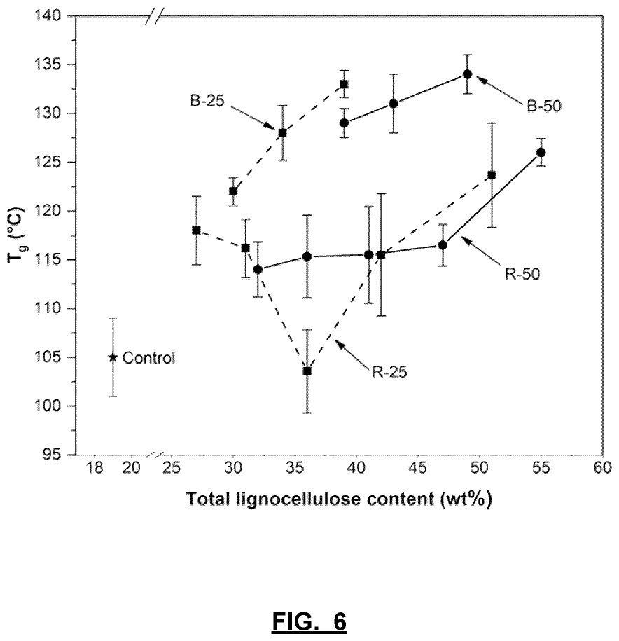

According to our previous study,¹⁸ the reactive extrusion would modify lignocellulose into a thermoplastic. FIG. 6 shows the modified lignocellulose's T_{g} for varying LC and different lubrication schemes. As a baseline for this discussion, a cleaned sample of the innate lubricant had a T_{g} of 105° C. (based on its preparation with an LC of 19 wt %, far lower than used in the recycle series). Only one of the recycle series samples at 36 wt % LC in the R-25 series showed a lower T_{g} (103° C.), and hence by the definition being used in this paper, it displayed improved thermoplasticity over the innate lubricant. Since this recycle condition used almost less than half of the amount of liquid modifier in the process compared to the condition used for the innate lubricant, it was considered a massive improvement for this process (albeit at too narrow of an operating point at present if the Ta must be as low as 105° C.).

Among the baseline conditions, B-25 and B-50 series, their T_{g} ranged from 120-135° C., much higher than their corresponding recycle series samples, though decreasing in value with lower LC to suggest an almost linear trend till reaching the T_{g} of the innate lubricant. Conversely, for very high LC, the modified samples eventually showed no detectable T_{g} (which in the case of the B-25 series occurred at an LC of 46 wt %). The R-25 series showed T_{g} varying between 104-124° C. while the R-50 series showed T_{g} varying between 114-126° C.; both series exhibited much lower T_{g} than their corresponding baseline samples. Although the R-50 series had a similar reaction efficiency to its corresponding B-50 series, it contained a high content of innate lubricant with low T_{g} (105° C.) to aid both processability but also the thermoplasticity of the final material.

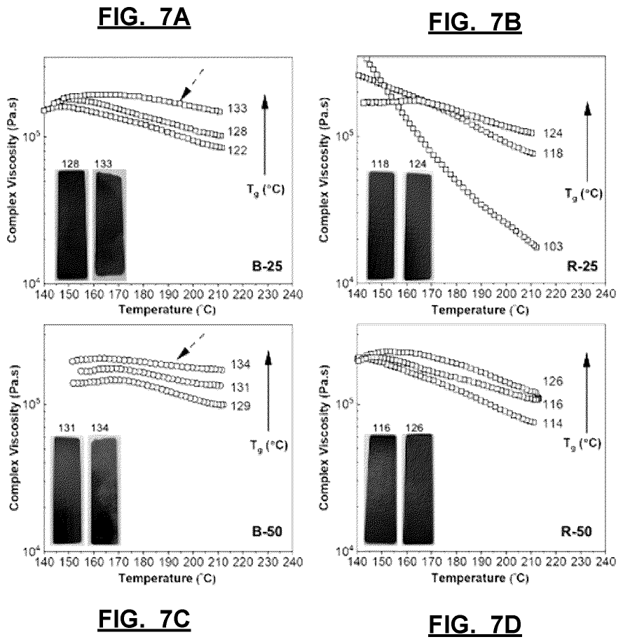

Thermoplasticily can also be conveyed by rheological characterization. FIGS. 7A, 7B, 7C and 7D shows the viscosity curves of the modified lignocellulose. Significant transition behavior, shown by a steep decline in viscosity with increasing temperature, was observed for the modified lignocellulose samples. Generally, samples with lower T_{g} presented a more significant transition, which was particularly noteworthy for the one sample from the R-25% series with the lowest T_{g} of 103° C. (FIG. 7B). Comparatively, the two samples (highlighted with dash arrows) with the highest T_{g} of 133° C. (FIG. 7A) and 134° C. (FIG. 70) from the baseline series showed no apparent transition behavior in their viscosity curves (highlighted by arrows). In our previous study,¹⁸ one of the other favoured methods for demonstrating thermoplasticity of the modified lignocellulose was to visually consider moldability, although in that case, the LC used was relatively low (14-19 wt %) versus 32-55 wt % in the present recycle stream series. Samples of any T_{g} in the R-25 or R-50 series showed good thermoplasticity by compression molding, with smooth surfaces to denote that the polymer flowed as a liquid under heat and pressure. However, not all samples of the B-25 or B-50 series showed the same good thermoplasticity, with the two samples of high T_{g}, either 133° C. or 134° C. showing poor filling of the mold due to incomplete melting.

### Tensile Property of the Modified Lignocellulose

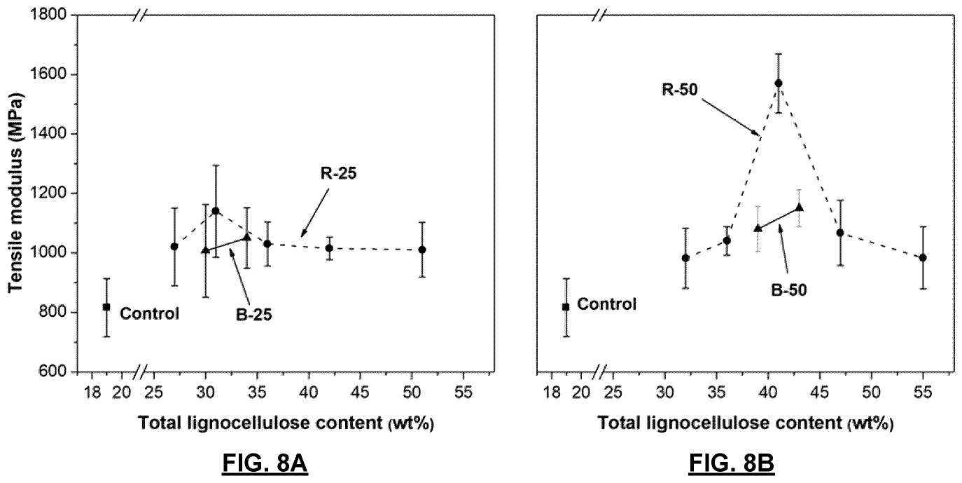

Besides processability, the mechanical properties were critical parameters for determining the applicability of the modified materials as suitable thermoplastics. FIGS. 8A and 8B show the tensile modulus of the modified lignocellulose made by reactive extrusion, tensile strength and elongation. For the baseline series (B-25 (FIG. 8A) and B-50 (FIG. 8B)), tensile measurements were limited to samples with Ta below 133° C. since other samples from the two series exhibiting a higher Ty had poor compression moldability and could not be prepared as test specimens. The thermoplastic lignocellulose prepared by reactive extrusion in the present study had a tensile strength of 18-31 MPa, modulus of 816-1570 MPa and elongation-at-break of 2.6%-6.1%, respectively. The new thermoplastic lignocellulose showed similar mechanical properties to commercial resins, e.g., polylactide acid, suggesting its suitability for practical industrial applications. The discussion to follow was based on the trend in modulus only since the strength property was much more sensitive to molding issues that arose with some samples.

Compared to the cleaned sample of the lubricant prepared at the highest LC in the study (i.e. control), all samples of the recycle and baseline series displayed higher tensile strength and modulus; these same samples had a higher Ta than the control. Only the sample in the R-25 series prepared with a 36 wt % LC had a T_{g} close to the control (103° C. versus 105° C.), though it still displayed higher tensile properties. Using a recycle stream for extrusion was viewed as beneficial in this regard since it not only allowed the use of less liquid modifier in the extrusion process but also offered the potential to obtaining a stiffer final product. Because of the acidic nature of the liquid modifier, in the case of the control, too high of a liquid modifier content in the extruder appeared to cause more significant degradation of the lignocellulose molecules²⁴, which explains the lower mechanical strength. The tensile modulus of the evaluated modified samples were generally higher with higher T_{g} values. However, the influence of T_{g} on tensile properties showed the opposite trend at very high LC, namely LC>42 wt % for R-25 series or LC>47 wt % for R-50 series. The decline in mechanical properties in this case was attributed to poorly moldablity.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A method of producing thermoplastic lignocellulose, the method comprising:
mixing a feed stream and a recycle stream to form a mixed feed stream, the feed stream comprising unmodified lignocellulose, the recycle stream comprising modified lignocellulose that has passed through an extruder;
providing the mixed feed stream to the extruder at a feed port of the extruder;
providing a liquid modifier to the extruder at a second port of the extruder, the second port being downstream from the feed port so that the liquid modifier mixes with the mixed feed stream within the extruder to initiate side-chain modification of the unmodified lignocellulose within the mixed feed stream, the liquid modifier comprising a cationic surfactant/sulfuric acid additive and an esterification agent; and
producing a product stream by the extruder at an outlet of the extruder, the product stream comprising the thermoplastic lignocellulose as extrudate.

2. (canceled)

3. (canceled)

4. The method of claim 1, wherein the mixing of the feed stream and the recycle stream comprises dry blending the feed stream and the recycle stream.

5. (canceled)

6. (canceled)

7. (canceled)

8. The method of claim 1, wherein the extruder has a temperature of about 120° C. at the second port, or wherein the extruder has a temperature of about 120° C. between the second port and the outlet.

9. (canceled)

10. The method of claim 1, wherein the liquid modifier stream is injected at a rate of about 6 ml/min to about 32 ml/min.

11. The method of claim 1, wherein the liquid modifier stream comprises a fluid comprising one or more of: benzethonium chloride (hyamine), acetic anhydride, sulfuric acid, and anhydrous ethanol.

12. The method of claim 1, further comprising separating a portion of the extrudate product stream to form the recycle stream.

13. The method of claim 1, wherein the extruder is a twin-screw extruder.

14. A mixed feed stream of lignocellulose for producing thermoplastic lignocellulose, comprising:
unmodified lignocellulose comprising mechanically pre-treated lignocellulose, and
modified lignocellulose that has passed through an extruder.

15. The mixed feed stream of claim 14, wherein said mixed stream comprises at least 25% w/w of said modified lignocellulose and up to 50% w/w of said modified lignocellulose.

16. The mixed feed stream of claim 14, wherein said mixed feed stream comprises about 19% w/w to about 65% w/w solids content.

17. The mixed feed stream of claim 14, wherein said mixed feed stream further comprises extruded lignocellulose that exhibits grafted acetyl group and/or grafted benzethonium sulfate group.

18. The mixed feed stream of claim 17, wherein the extruded lignocellulose exhibits a content of grafted acetyl group greater than 2.3 mmol/g.

19. The mixed feed stream of claim 14, wherein said mixed stream comprises a glass transition temperature (T_{g}) of about 103° C. to about 135° C.

20. The mixed feed stream of claim 14, further comprising a liquid modifier comprising a cationic compound, a sulfuric acid additive and an esterification agent.

21. The mixed feed stream of claim 20, wherein the esterification agent comprises an acetic anhydride.

22. The mixed feed stream of claim 20, wherein the cationic compound consists of benzethonium chloride.

23. A process for producing thermoplastic lignocellulose, comprising: obtaining a mixed feed stream of lignocellulose as defined in claim 14; and using said mixed feed stream as an innate lubricant.

24. A compression mouldable thermoplastic lignocellulose, comprising the following mechanical properties:
a tensile a strength of about 18 to about 31 MPa;
a tensile modulus of about 816 to about 1570 MPa; and
an elongation-at-break of about 2.6% to about 6.1%.

25. A compression-molded article of manufacture, prepared by compression molding of the compression mouldable thermoplastic lignocellulose as defined in claim 24.
